(19) United States
(12) Patent Application Publication
(10) Pub. No.: US 2011/0209128 A1
(43) Pub. Date: Aug. 25, 2011

(54) SYSTEMS, METHODS AND APPARATUSES FOR FACILITATING TARGETED COMPILATION OF SOURCE CODE

(75) Inventors: Jari Nikara, Lempaala (FI); Eero Aho, Tampere (FI); Tapani Leppänen, Tampere (FI)

(73) Assignee: Nokia Corporation

(21) Appl. No.: 12/711,662

(22) Filed: Feb. 24, 2010

(51) Int. Cl. G06F 9/45

(52) U.S. Cl. 717/140; 717/177

(57) ABSTRACT

Methods, apparatuses, and systems are provided for facilitating targeted compilation of source code. A method may include receiving source code for an application. The method may further include determining information about an execution platform of an end user apparatus on which the application will be executed. The method may additionally include compiling the source code based at least in part on the determined information into an executable targeted to the execution platform of the end user apparatus. The method may also include causing the executable to be sent to the end user apparatus. Corresponding apparatuses and systems are also provided.

### TECHNOLOGICAL FIELD

Embodiments of the present invention relate generally to computing technology and, more particularly, relate to systems, methods, and apparatuses for facilitating targeted compilation of source code.

### BACKGROUND

The modern computing era has brought about a tremendous expansion in computing power as well as increased portability and affordability of computing devices. This expansion has resulted in a wide variety of computing platforms being used by consumers from all walks of life in their everyday lives. These computing platforms have a wide variety of hardware and software configurations, each of which may present a unique execution platform for software applications. Accordingly, a software application developed for one execution platform may not function properly when executed on a second execution platform.

The potential for application incompatibility may pose a problem for software developers and distributors when the execution platform(s) on which end users will implement an application is not known. This problem may be magnified by the increasing number of different execution platforms in use by consumers. As a result, consumers may increasingly face software incompatibility issues, which may range from software not even being installable on a particular platform to software not functioning properly once installed. These incompatibility issues may negatively impact consumer experience and may foster a negative opinion of software developers and distributors in the minds of impacted consumers.

### BRIEF SUMMARY

Systems, methods, apparatuses, and computer program products described herein facilitate targeted compilation of source code. The systems, methods, apparatuses, and computer program products provided in accordance with example embodiments of the invention may provide several advantages to application developers, application distributors, computing devices, and computing device users. Example embodiments of the invention provide targeted, on-demand compilation of source code. In this regard, some example embodiments provide on-the-fly (e.g., dynamic) compilation of source code for a requesting end-user that is targeted to an end-user's apparatus. Accordingly, application developers and distributors may be enabled to develop a single application source code that may be targeted on demand for a variety of execution platforms without knowledge of the execution platform(s) on which the application will ultimately be implemented. Example embodiments further provide for targeted compilation of source code without imposing any requirement on end user apparatuses to compile the source code. In this regard, some example embodiments implement targeted compilation as a network service that may compile source code prior to delivery to an end user apparatus and/or at the request of an end user apparatus. Accordingly, end user apparatuses are not burdened by the processing requirements of compilation. Further, end users are not burdened with compiling the source code and thus are not required to possess the technical knowledge of how to compile source code such that the compiled executable is compatible with their computing devices.

Some example embodiments additionally provide for subsequent recompilation (e.g., retargeting) of source code for an end user apparatus for which the source code has been previously compiled (e.g., targeted). Accordingly, applications may be retargeted to account for changes in hardware and/or software configurations of an execution platform. Further, some example embodiments provide for retargeting to accommodate changed user preferences and/or runtime load balancing. Additionally, some example embodiments provide for retargeting in instances where an end user apparatus comprises a plurality of processors having different instruction sets such that source code may be retargeted to facilitate execution on a different execution platform of a computing device.

In a first example embodiment, a method is provided, which comprises receiving source code for an application. The method of this embodiment further comprises determining information about an execution platform of an end user apparatus on which the application will be executed. The method of this embodiment additionally comprises compiling the source code based at least in part on the determined information into an executable targeted to the execution platform of the end user apparatus. The method of this embodiment also comprises causing the executable to be sent to the end user apparatus.

In another example embodiment, an apparatus is provided. The apparatus of this embodiment comprises at least one processor and at least one memory storing computer program code, wherein the at least one memory and stored computer program code are configured, with the at least one processor, to cause the apparatus to at least receive source code for an application. The at least one memory and stored computer program code are configured, with the at least one processor, to further cause the apparatus of this embodiment to determine information about an execution platform of an end user apparatus on which the application will be executed. The at least one memory and stored computer program code are configured, with the at least one processor, to additionally cause the apparatus of this embodiment to compile the source code based at least in part on the determined information into an executable targeted to the execution platform of the end user apparatus. The at least one memory and stored computer program code are configured, with the at least one processor, to also cause the apparatus of this embodiment to cause the executable to be sent to the end user apparatus.

In another example embodiment, a computer program product is provided. The computer program product of this embodiment includes at least one computer-readable storage medium having computer-readable program instructions stored therein. The program instructions of this embodiment comprise program instructions configured to receive source code for an application. The program instructions of this embodiment further comprise program instructions configured to determine information about an execution platform of an end user apparatus on which the application will be executed. The program instructions of this embodiment also comprise program instructions configured to compile the source code based at least in part on the determined information into an executable targeted to the execution platform of the end user apparatus. The program instructions of this embodiment additionally comprise program instructions configured to cause the executable to be sent to the end user apparatus.

In another example embodiment, an apparatus is provided that comprises means for receiving source code for an application. The apparatus of this embodiment further comprises means for determining information about an execution platform of an end user apparatus on which the application will be executed. The apparatus of this embodiment additionally comprises means for compiling the source code based at least in part on the determined information into an executable targeted to the execution platform of the end user apparatus. The apparatus of this embodiment also comprises means for causing the executable to be sent to the end user apparatus.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a block diagram of a system or facilitating targeted compilation of source code according to an example embodiment of the invention;

FIG. 2 is a schematic block diagram of a mobile terminal according to an example embodiment of the present invention;

FIG. 3 illustrates a block diagram of an end user apparatus for facilitating targeted compilation of source code according to an example embodiment of the invention;

FIG. 4 illustrates a block diagram of a code compilation apparatus for facilitating targeted compilation of source code according to an example embodiment of the invention;

FIG. 5 illustrates a block diagram of a system for providing a plurality of services, including targeted source code compilation, in accordance with an example embodiment of the invention;

FIG. 6 illustrates a signaling diagram of signals that may be exchanged between entities of the system of FIG. 1 for facilitating targeted compilation of source code according to an example embodiment of the invention;

FIG. 7 illustrates a signaling diagram of signals that may be exchanged between entities of the system of FIG. 1 for facilitating targeted compilation of source code according to another example embodiment of the invention; and

FIG. 8 illustrates a flowchart according to an example method for facilitating targeted compilation of source code according to an example embodiment of the invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

Software developers often develop software without knowing and sometimes without having control over what execution platform(s) the software will be implemented on. Careful tailoring or optimization of software for an execution platform requires thorough knowledge by the developer of the platform and respective development environment. Furthermore, tailored solutions are not very portable and it is difficult for a developer to develop versions of software so as to account for all possible execution platform cases.

Distribution of original source code to end users for compilation on the end user's apparatus may pose further problems. In this regard, when an end user receives software as source code and must compile the code, the end user may be required to have access to a development environment (at least the compiler), relatively good software development skills, and knowledge of the final execution platform. Accordingly, ease of use and access to software may be impacted through this alternative.

Distribution of software as executable binaries requires the careful identification of the final execution environment by developer as well as by end-user. Even small variations in execution platforms may require individual binary releases. This requirement may lead to a large number of different binary releases that need to be maintained and updated during application life time, thus imposing an increased burden on software developers. In the worst case, variations may cause incompatibility. In addition, when distributed as precompiled binaries, the compilation cannot be optimized according the user preferences or usage of the platform. From a developer perspective, when software is distributed as binaries, the software is essentially targeted to a limited amount of platforms, thus limiting the potential market for the software.

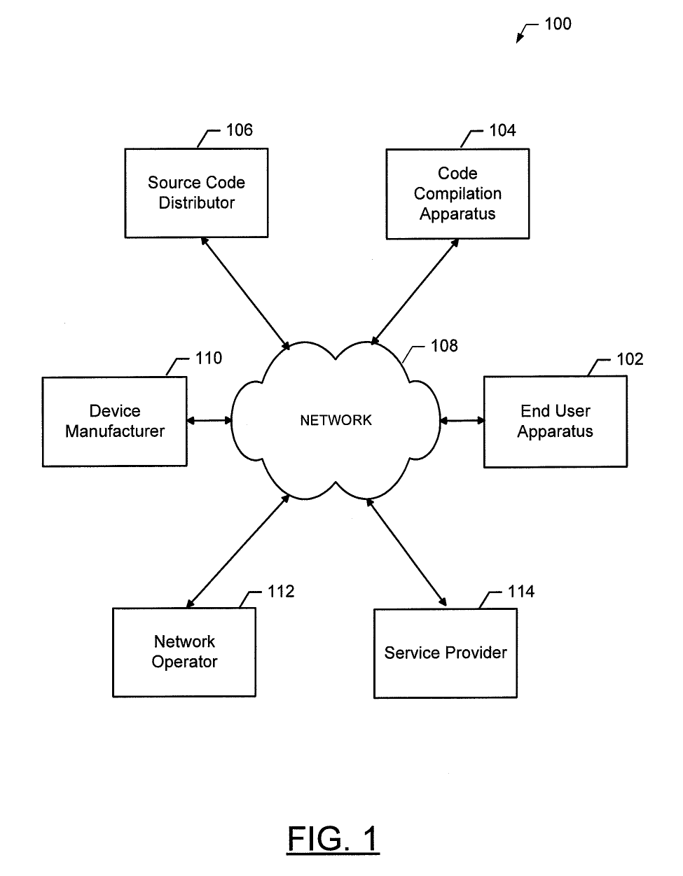

Example embodiments of the invention accordingly provide systems, methods, apparatuses, and computer program products that facilitate targeted compilation of source code. FIG. 1 illustrates a block diagram of a system 100 for facilitating targeted compilation of source code according to an example embodiment of the present invention. It will be appreciated that the system 100 as well as the illustrations in other figures are each provided as an example of one embodiment of the invention and should not be construed to narrow the scope or spirit of the invention in any way. In this regard, the scope of the disclosure encompasses many potential embodiments in addition to those illustrated and described herein. As such, while FIG. 1 illustrates one example of a configuration of a system for facilitating targeted compilation of source code, numerous other configurations may also be used to implement embodiments of the present invention.

In at least some embodiments, the system 100 includes an end user apparatus 102, code compilation apparatus 104, and source code distributor 106 in communication over a network 108. The network 108 may comprise a wireless network (e.g., a cellular network, wireless local area network, wireless metropolitan area network, and/or the like), a wireline network, or some combination thereof, and in some embodiments comprises the internet.

The end user apparatus 102 may be embodied as any computing device including, for example, a desktop computer, laptop computer, mobile terminal, mobile computer, mobile phone, mobile communication device, game device, digital camera/camcorder, audio/video player, television device, radio receiver, digital video recorder, positioning device, wrist watch, portable digital assistant (PDA), remote control, any combination thereof, and/or the like. In one example embodiment, the end user apparatus 102 comprises or is embodied on a mobile phone. The mobile phone of this embodiment may comprise user interface circuitry and user interface software stored on one or more memories. The user interface circuitry and user interface software may be configured to facilitate user control of at least some functions of the mobile phone through use of a display and to cause at least a portion of a user interface of the mobile phone to be displayed on the display to facilitate user control of at least some functions of the mobile phone.

The code compilation apparatus 104 may comprise any computing device or plurality of computing devices that is configured to receive source code, such as from the source code distributor 106 and/or from the end user apparatus 102 and provide for targeted on-demand compilation of the source code for an execution platform of the end user apparatus 102, as will be further described herein. In this regard, the code compilation apparatus 104 may comprise, for example, one or more servers, one or more network nodes, a desktop computer, laptop computer, some combination thereof, or the like.

The source code distributor 106 may comprise one or more computing devices configured to provide source code for distribution, such as to an end user, over the network 108. Accordingly, the source code distributor may comprise, for example, one or more servers, one or more network nodes, a desktop computer, laptop computer, some combination thereof, or the like. The source code distributor 106 may be maintained by a software developer or may comprise a third party distribution channel facilitating distribution of a developer's applications. Although illustrated in FIG. 1 as separate entities, the source code distributor 106 and code compilation apparatus 104 may be co-located and/or under common control.

The system 100 may additionally comprise one or more information sources from which the code compilation apparatus 104 may obtain information about an execution platform of the end user apparatus 102. These information sources may comprise any computing device configured to store and/or provide information about an end user, an end user apparatus 102, a service used by the end user apparatus 102, a software configuration of the end user apparatus 102, a hardware configuration of the end user apparatus 102, and/or the like. Three such information sources (the device manufacturer 110, network operator 112, and service provider 114) are illustrated in FIG. 1 by way of example. It will be appreciated that the system 100 may comprise a subset of the information sources illustrated in FIG. 1. The system 100 may also comprise one or more information sources in addition to or in lieu of the information sources illustrated in FIG. 1.

The device manufacturer 110 may comprise any computing device or plurality of computing devices configured to provide information about an end user apparatus 102 and/or a hardware configuration thereof to the code compilation apparatus 104. The network operator 112 may comprise any computing device or plurality of computing devices configured to provide the code compilation apparatus 104 with information about a network subscriber (e.g., an end user of an end user apparatus 102), network capabilities, end user subscription information, and/or the like that may affect the capabilities of an execution platform on the end user apparatus 102. The service provider 114 may comprise any computing device or plurality of computing devices configured to provide the code compilation apparatus 104 with information about service requirements/capabilities of a service used and/or subscribed to by an end user of an end user apparatus 102, end user preferences, an end user service profile, and/or the like.

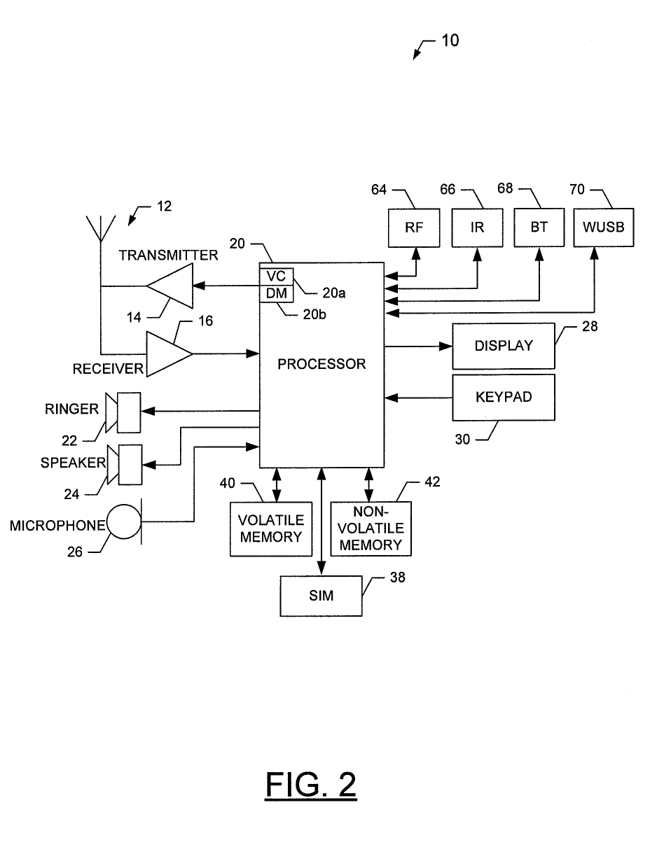

In an example embodiment, the end user apparatus 102 is embodied as a mobile terminal, such as that illustrated in FIG. 2. In this regard, FIG. 2 illustrates a block diagram of a mobile terminal 10 representative of one embodiment of an end user apparatus 102 in accordance with some example embodiments. It should be understood, however, that the mobile terminal 10 illustrated and hereinafter described is merely illustrative of one type of end user apparatus 102 that may implement and/or benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wireless-Fidelity (Wi-Fi), wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (for example, digital/analog or TDMA/CDMA/analog phones). Additionally, the mobile terminal 10 may be capable of operating according to Wireless Fidelity (Wi-Fi) or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the interne or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (for example, software and/or firmware) stored on a memory accessible to the processor 20 (for example, volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (for example, Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, IEEE 802.15 techniques, IEEE 802.16 techniques, and/or the like.

The mobile terminal 10 may comprise memory, such as a subscriber identity module (SIM) 38, a universal subscriber identity module (USIM), a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (for example, hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

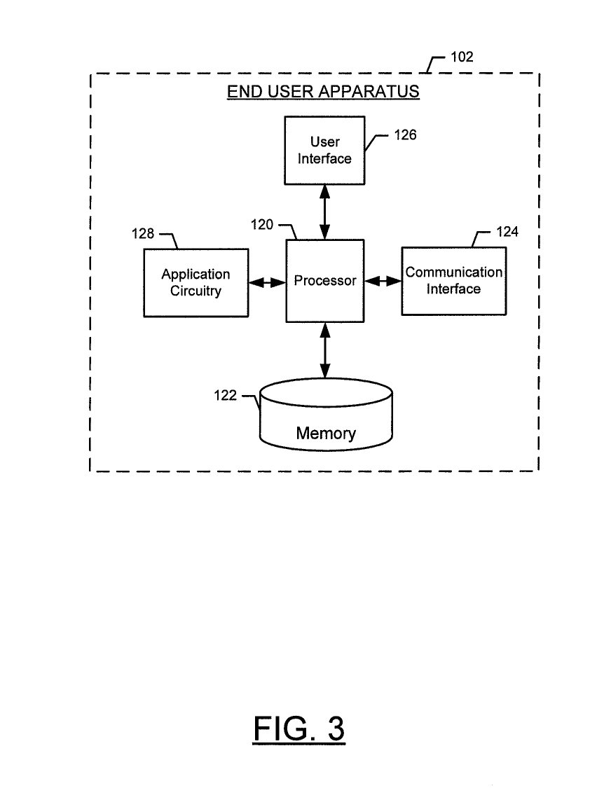

Referring now to FIG. 3, FIG. 3 illustrates a block diagram of an end user apparatus 102 for facilitating targeted compilation of source code according to an example embodiment of the invention. In the example embodiment illustrated in FIG. 3, the end user apparatus 102 may include various means, such as a processor 120, memory 122, communication interface 124, user interface 126, and application circuitry 128 for performing the various functions herein described. These means of the end user apparatus 102 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example, memory 122) that is executable by a suitably configured processing device (for example, the processor 120), or some combination thereof.

The processor 120 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 3 as a single processor, in some embodiments the processor 120 comprises a plurality of processors. The plurality of processors may be in operative communication with each other and may be collectively configured to perform one or more functionalities of the end user apparatus 102 as described herein. In embodiments wherein the end user apparatus 102 is embodied as a mobile terminal 10, the processor 120 may be embodied as or comprise the processor 20. In an example embodiment, the processor 120 is configured to execute instructions stored in the memory 122 or otherwise accessible to the processor 120. These instructions, when executed by the processor 120, may cause the end user apparatus 102 to perform one or more of the functionalities of the end user apparatus 102 as described herein. As such, whether configured by hardware or software methods, or by a combination thereof, the processor 120 may comprise an entity capable of performing operations according to embodiments of the present invention while configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, such as may be stored in the memory 122, the instructions may specifically configure the processor 120 to perform one or more algorithms and operations described herein.

The memory 122 may comprise, for example, volatile memory, non-volatile memory, or some combination thereof. Although illustrated in FIG. 3 as a single memory, the memory 122 may comprise a plurality of memories. In various embodiments, the memory 122 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the end user apparatus 102 is embodied as a mobile terminal 10, the memory 122 may comprise the volatile memory 40 and/or the non-volatile memory 42. The memory 122 may be configured to store information, data, applications, instructions, and/or the like for enabling the end user apparatus 102 to carry out various functions in accordance with example embodiments of the present invention. For example, in at least some embodiments, the memory 122 is configured to buffer input data for processing by the processor 120. Additionally or alternatively, in at least some embodiments, the memory 122 is configured to store program instructions for execution by the processor 120. The memory 122 may store information in the form of static and/or dynamic information. This stored information may be stored and/or used by the application circuitry 128 during the course of performing its functionalities.

The communication interface 124 may be embodied as any device or means embodied in circuitry, hardware, a computer program product comprising computer readable program instructions stored on a computer readable medium (for example, the memory 122) and executed by a processing device (for example, the processor 120), or a combination thereof that is configured to receive and/or transmit data from/to another entity, such as over a network. In at least one embodiment, the communication interface 124 is at least partially embodied as or otherwise controlled by the processor 120. In this regard, the communication interface 124 may be in communication with the processor 120, such as via a bus. The communication interface 124 may include, for example, an antenna, a transmitter, a receiver, a transceiver and/or supporting hardware or software for enabling communications with one or more computing devices or entities over the network 108. The communication interface 124 may be configured to receive and/or transmit data using any protocol that may be used for communications between the end user apparatus 102 and one or more other computing devices over the network 108 (e.g., the code compilation apparatus 104, source code distributor 106, a service provider, network access point, and/or the like). The communication interface 124 may additionally be in communication with the memory 122, user interface 126, and/or application circuitry 128, such as via a bus.

The user interface 126 may be in communication with the processor 120 to receive an indication of a user input and/or to provide an audible, visual, mechanical, or other output to a user. As such, the user interface 126 may include, for example, a keyboard, a mouse, a joystick, a display, a touch screen display, a microphone, a speaker, and/or other input/output mechanisms. In this regard, the user interface 126 may, for example, facilitate user selection and ordering of an application from a source code distributor 106. As another example, the user interface 126 may facilitate user demand for targeting and/or retargeting source code. The user interface 126 may be in communication with the memory 122, communication interface 124, and/or application circuitry 128, such as via a bus.

The application circuitry 128 may be embodied as various means, such as circuitry, hardware, a computer program product comprising computer readable program instructions stored on a computer readable medium (for example, the memory 122) and executed by a processing device (for example, the processor 120), or some combination thereof and, in one embodiment, is embodied as or otherwise controlled by the processor 120. In embodiments wherein the application circuitry 128 is embodied separately from the processor 120, the application circuitry 128 may be in communication with the processor 120. The application circuitry 128 may further be in communication with one or more of the memory 122, communication interface 124, or user interface 126, such as via a bus.

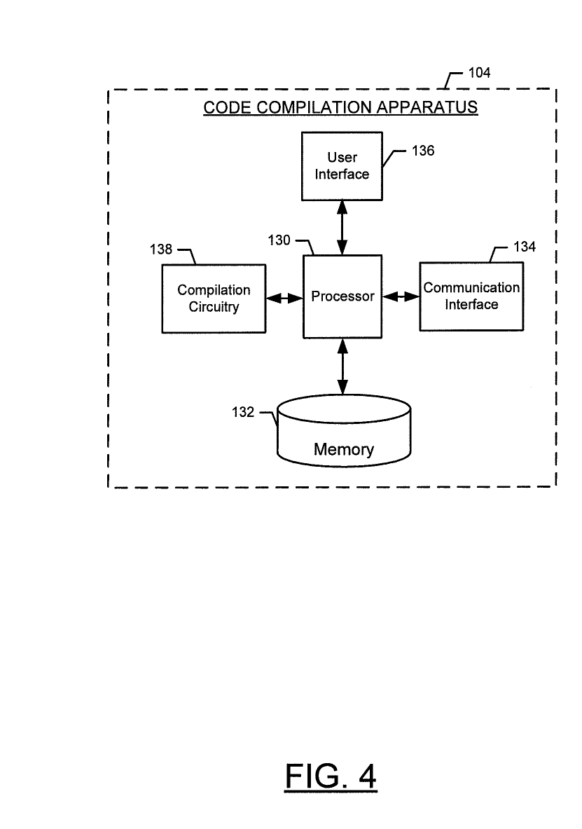

FIG. 4 illustrates a block diagram of a code compilation apparatus 104 for facilitating targeted compilation of source code according to an example embodiment of the invention. In the example embodiment illustrated in FIG. 4, the code compilation apparatus 104 may include various means, such as a processor 130, memory 132, communication interface 134, user interface 136, and compilation circuitry 138 for performing the various functions herein described. These means of the code compilation apparatus 104 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example, memory 132) that is executable by a suitably configured processing device (for example, the processor 130), or some combination thereof.

The processor 130 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 4 as a single processor, in some embodiments the processor 130 comprises a plurality of processors. The plurality of processors may be in operative communication with each other and may be collectively configured to perform one or more functionalities of the code compilation apparatus 104 as described herein. The plurality of processors may be embodied on a single computing device or may be distributed across a plurality of computing devices collectively configured to perform one or more functionalities of the code compilation apparatus 104 as described herein. In an example embodiment, the processor 130 is configured to execute instructions stored in the memory 132 or otherwise accessible to the processor 130. These instructions, when executed by the processor 130, may cause the code compilation apparatus 104 to perform one or more of the functionalities of the code compilation apparatus 104 as described herein. As such, whether configured by hardware or software methods, or by a combination thereof, the processor 130 may comprise an entity capable of performing operations according to embodiments of the present invention while configured accordingly. Thus, for example, when the processor 130 is embodied as an ASIC, FPGA or the like, the processor 130 may comprise specifically configured hardware for conducting one or more operations described herein. Alternatively, as another example, when the processor 130 is embodied as an executor of instructions, such as may be stored in the memory 132, the instructions may specifically configure the processor 130 to perform one or more algorithms and operations described herein.

The memory 132 may comprise, for example, volatile memory, non-volatile memory, or some combination thereof. Although illustrated in FIG. 4 as a single memory, the memory 132 may comprise a plurality of memories. The plurality of memories may be embodied on a single computing device or distributed across a plurality of computing devices that may collectively comprise the code compilation apparatus 104. In various embodiments, the memory 132 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 132 may be configured to store information, data, applications, instructions, or the like for enabling the code compilation apparatus 104 to carry out various functions in accordance with example embodiments of the present invention. For example, in at least some embodiments, the memory 132 is configured to buffer input data for processing by the processor 130. Additionally or alternatively, in at least some embodiments, the memory 132 is configured to store program instructions for execution by the processor 130. The memory 132 may store information in the form of static and/or dynamic information. This stored information may be stored and/or used by compilation circuitry 138 during the course of performing its functionalities.

The communication interface 134 may be embodied as any device or means embodied in circuitry, hardware, a computer program product comprising computer readable program instructions stored on a computer readable medium (for example, the memory 132) and executed by a processing device (for example, the processor 130), or a combination thereof that is configured to receive and/or transmit data from/to a device, such as over the network 108. In at least one embodiment, the communication interface 134 is at least partially embodied as or otherwise controlled by the processor 130. In this regard, the communication interface 134 may be in communication with the processor 130, such as via a bus. The communication interface 134 may include, for example, an antenna, a transmitter, a receiver, a transceiver and/or supporting hardware or software for enabling communications with a device over a network. The communication interface 134 may be configured to receive and/or transmit data using any protocol that may be used for communications between the code compilation apparatus 104 and one or more other computing devices over the network 108 (e.g., an end user apparatus 102, source code distributor 106, a service provider, information source, and/or the like). The communication interface 134 may additionally be in communication with the memory 132, user interface 136, and/or compilation circuitry 138, such as via a bus.

The user interface 136 may be in communication with the processor 130 to receive an indication of a user input and/or to provide an audible, visual, mechanical, or other output to a user. As such, the user interface 136 may include, for example, a keyboard, a mouse, a joystick, a display, a touch screen display, a microphone, a speaker, and/or other input/output mechanisms. In embodiments wherein the code compilation apparatus 104 is embodied as one or more servers, elements of the user interface 136 may be limited or the user interface 136 may be eliminated entirely. The user interface 136 may be in communication with the memory 132, communication interface 134, and/or compilation circuitry 138, such as via a bus.

The compilation circuitry 138 may be embodied as various means, such as circuitry, hardware, a computer program product comprising computer readable program instructions stored on a computer readable medium (for example, the memory 132) and executed by a processing device (for example, the processor 130), or some combination thereof and, in one embodiment, is embodied as or otherwise controlled by the processor 130. In embodiments wherein the compilation circuitry 138 is embodied separately from the processor 130, the compilation circuitry 138 may be in communication with the processor 130. The compilation circuitry 138 may further be in communication with the memory 132, communication interface 134, and/or user interface 136, such as via a bus.

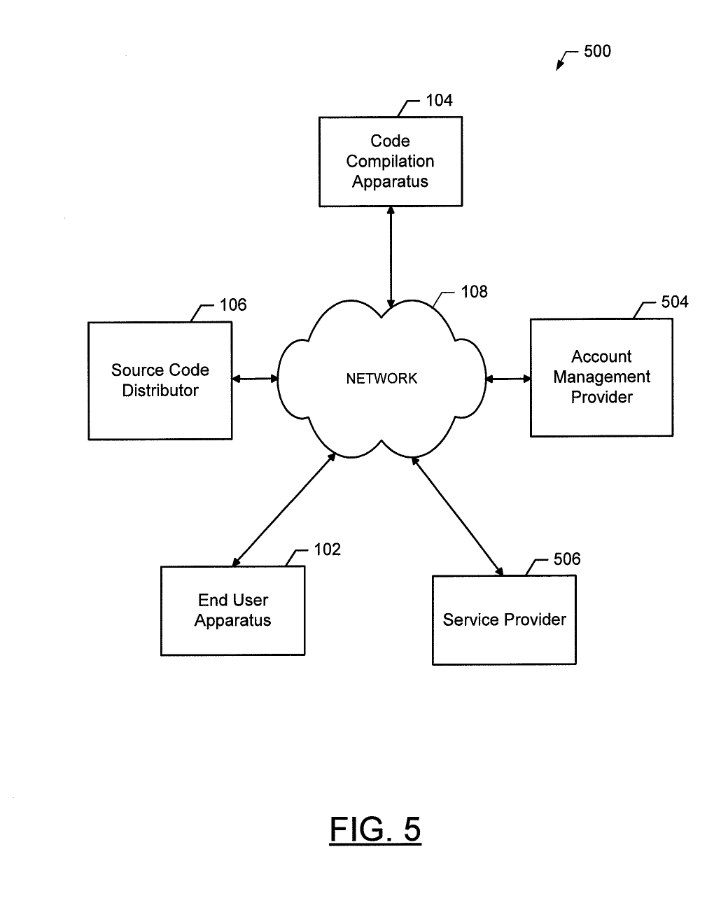

In some embodiments, the system 100 may comprise a portion of a system for providing a plurality of services to users of computing devices, such as, for example, a user device 102. Referring now to FIG. 5, an embodiment of a system 500 for providing a plurality of services, including targeted source code compilation, to computing devices in accordance with aspects of the present invention is illustrated. The system 500 may include an account management provider 504 and one or more service providers 506 in addition to one or more entities of the system 100. In this regard, for example, the end user device 102, the code compilation apparatus 104, source code distributor 106, the account management provider 504, and one or more service providers 506 may be interconnected via the network 108.

The account management provider 504 may comprise any computing device or plurality of computing devices configured to (e.g., through specially configured hardware, such as, an appropriately configured processor, and/or through specially configured software instructions embodied on a computer readable medium, such as may be executed by a processor) provide a single service sign-on and/or interface to a plurality of services and/or service providers such that a user of a computing device (e.g., an end user apparatus 102) may access a plurality of services through a single integrated account interface provided by the account management provider 504. Accordingly, in an example embodiment, the account management provider 504 comprises a service provider in that the account management provider 504 provides a gateway to a plurality of services. A “service” may include a provider of data or other content as well as services, such as, for example, e-mail, instant messaging, multi-player gaming, peer-to-peer file transfer, web browsing, social networking, photograph hosting, video hosting, and other multimedia hosting services that may be accessed by and/or supplied to remote computing devices over a network or communications link, such as the network 108. In this regard, the distribution of source code by the source code distributor 106 and/or targeted source code compilation provided by the code compilation apparatus 104 may comprise a service. Accordingly, an end user may be able to the source code distributor and/or targeted compilation services provided by the code compilation apparatus 104 through the account management provider 504. Users may register computing devices, such as, for example, an end user device 102, with the account management provider 504 such that the user may access services from the account management provider 504 using the end user device 102. These services may be provided by the code compilation apparatus 104, source code distributor 106, service provider 506, and/or the like. Although only one service provider 320 is shown in FIG. 5, the system 500 may comprise a plurality of service providers 506. In this regard, each service provider 506 represents a service provider, such as, for example, a multimedia service provider, social networking service provider, or the like, which may be accessed through the account management provider 504.

Accordingly, a user of an end user device 102 may register or otherwise interface an end user device 102 with the account management provider 504. Subsequent to registering an end user device 102 with the account management provider 504 in such embodiments, a user may log into the account management provider 504 and access source code distribution and/or targeted compilation services as described in connection to the system 100.

Returning to FIGS. 1-4, a user of an end user apparatus 102 may select an application available from the source code distributor 106. The application circuitry 128 may be configured to cause an order request to be communicated to the source code distributor 106 so that the source code distributor may distribute the source code for the ordered application. If the user is required to pay a charge for ordering the application, such payment arrangements may be made according to any method of payment that may be utilized by the source code distributor 106.

After an application has been ordered, the source code distributor 106 may be configured to provide the source code for the ordered application to one or more of the end user apparatus 102 or the code compilation apparatus 104. In embodiments wherein the source code distributor 106 provides the source code to the end user apparatus 102, the end user apparatus 102 (e.g., the processor 120 and/or application circuitry 128 of the end user apparatus 102) may be configured to send the source code to the code compilation apparatus 104 for targeted compilation.

The compilation circuitry 138 of the code compilation apparatus 104 may be configured to receive source code sent to the code compilation apparatus 104. In this regard, the source code may be sent to the code compilation apparatus 104 by the source code distributor 106 in response to an order request by an end user and/or by an end user apparatus 102, as described above. Additionally or alternatively, the source code may be sent to the code compilation apparatus 104 by an end user apparatus 102 in response to a request by a user and/or a request by the end user apparatus to have the source code compiled.

The compilation circuitry 138 may be further configured to determine information about an execution platform of the end user apparatus 102 on which the application is to be executed. The execution platform may comprise any execution environment embodied on the end user apparatus 102 and may, for example, be characterized by a hardware and/or software configuration of the execution environment. For example, the execution environment may comprise one or more processors and an associated instruction set. Additionally or alternatively, the execution environment may comprise an operating system on top of which the compiled application will be run, one or more other applications implemented on the end user apparatus 102, and/or the like. In one example, the execution platform may comprise a virtual machine executed on the end user apparatus 102.

The compilation circuitry 138 may be configured to determine information by extracting information included in a request for targeted compilation of source code. This information may, for example, include identification information identifying the end user apparatus 102. The identification information may, for example, comprise one or more of a serial number of the end user apparatus 102, a phone number of the end user apparatus 102, an international mobile equipment identity (IMEI) of the end user apparatus 102, a media access control (MAC) address of the end user apparatus 102, a type of the end user apparatus 102 (e.g., make and model), a username of a user (e.g., a username used for accessing a service) of the end user apparatus 102, or the like. The compilation circuitry 138 may be configured to use determined identification information to determine information about the execution platform. In this regard, the compilation circuitry 138 may use the identification information to obtain information about the end user apparatus 102 from one or more entities of the system 100.

The compilation circuitry 138 may determine information from one or more information sources. When obtaining information from information sources, the compilation circuitry 138 may utilize determined identification information in order to retrieve the appropriate information about the execution platform of the end user apparatus 102. As an example, the compilation circuitry 138 may determine information about the end user apparatus 102, a hardware configuration of an execution platform of the end user apparatus 102, a capability of a user interface of the end user apparatus 102 (e.g., of the user interface 126), an operating system implemented on the execution platform, a runtime library implemented on the execution platform, a software configuration of the execution platform, a type of the end user apparatus 102, and/or the like from the device manufacturer 110. As another example, the compilation circuitry 138 may determine network subscriber information for the end user apparatus 102 or user thereof, network capabilities, network access restrictions, and/or the like from the network operator 112. As a further example, the compilation circuitry 138 may determine customer information, user profile information, user preferences, service capabilities, service requirements, and/or the like from a service provider 114.

The compilation circuitry 138 may additionally or alternatively determine information from an end user apparatus 102, itself, and/or a user thereof. This information may, for example, comprise a device type of the end user apparatus 102 (e.g., make and model), resource usage statistics of the execution platform, available resources on the execution platform, a runtime library implemented on the execution platform, a user profile, user preferences, a runtime platform load profile for the execution platform, an operating system implemented on the execution platform, one or more applications implemented on the execution platform, a hardware configuration of the execution platform, a software configuration of the execution platform, run-time statistics, and/or the like. As another example, the compilation circuitry 138 may be configured to determine information from the source code distributor 106. This information may, for example, include libraries needed for targeted compilation of the source code, compilation scripts, and/or the like.

Accordingly, the compilation circuitry 138 may be configured to determine a variety of information about an execution platform of the end user apparatus 102 from any number of entities of the system 100. The above provided examples of information that may be determined by the compilation circuitry 138 are provided by way of example, and not by way of limitation. In this regard, the compilation circuitry 138 may be configured to obtain additional or alternative information about an execution platform of an end user apparatus 102. Further, where the compilation circuitry 138 is described above to obtain a particular type of information from a particular source, it will be appreciated that the compilation circuitry 138 may be configured to obtain that information from an additional or alternative source. Thus, for example, information described to be obtained from a device manufacturer 110 may be obtained directly from the end user apparatus 102 and vice versa in various embodiments. In some embodiments, at least some of the determined information may comprise metadata.

The compilation circuitry 138 may be further configured to compile received source code into an executable targeted to a particular execution platform of an end user apparatus 102 based at least in part upon information determined about the execution platform. In this regard, for example, the compilation circuitry 138 may generate a compiled binary that is targeted to the capabilities of an execution platform, end user preferences, and/or the like. It will be appreciated that the compiled executable may be in any format and not just an executable binary. Accordingly, the format of the executable may comprise any format that is executable on the targeted execution platform. Other example formats for the executable include byte code, optimized code, an intermediate code representation interpretable by the execution platform, and/or the like. Accordingly, the compilation circuitry 138 may determine an appropriate format for the executable based on the information determined about the execution platform. As an example of targeted compilation of source code, the compilation circuitry 138 may determine from user preferences that an end user likes to listen to music while playing games and may determine from profile information that the user prefers to use display and headset user interface elements. The compilation circuitry 138 may be configured to compile source code for a game such that the resulting executable is targeted to use the user preferred user interface elements while ensuring sufficient free resources to allow for playback of music when the user is playing the game.

Concurrent with or prior to compiling source code, the compilation circuitry 138 may perform one or more code verification services. In this regard, the compilation circuitry 138 may, for example, perform code assessment on the source code, a virus scan of the source code, and/or the like.

After compiling a targeted executable, the compilation circuitry 138 may be configured to send the executable to the end user apparatus 102. The executable may then be executed on the intended execution platform of the end user apparatus 102.

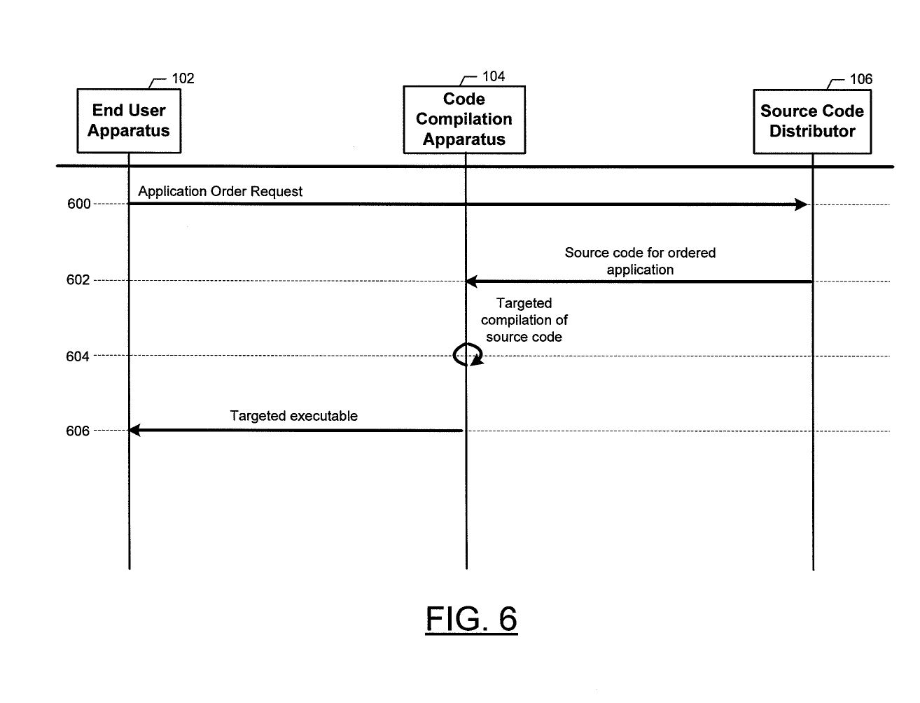

FIG. 6 illustrates a signaling diagram of signals that may be exchanged between entities of the system 100 for facilitating targeted compilation of source code according to an example embodiment of the invention. Operation 600 may comprise the end user apparatus 102 sending an application order request for an application to the source code distributor 106. Operation 602 may comprise the source code distributor 106 sending the source code for the ordered application to the code compilation apparatus 104. Operation 604 may comprise the code compilation apparatus 104 compiling the source code into an executable that is targeted to an intended execution platform of the end user apparatus 102. Operation 606 may comprise the code compilation apparatus 104 sending the targeted executable to the end user apparatus 102.

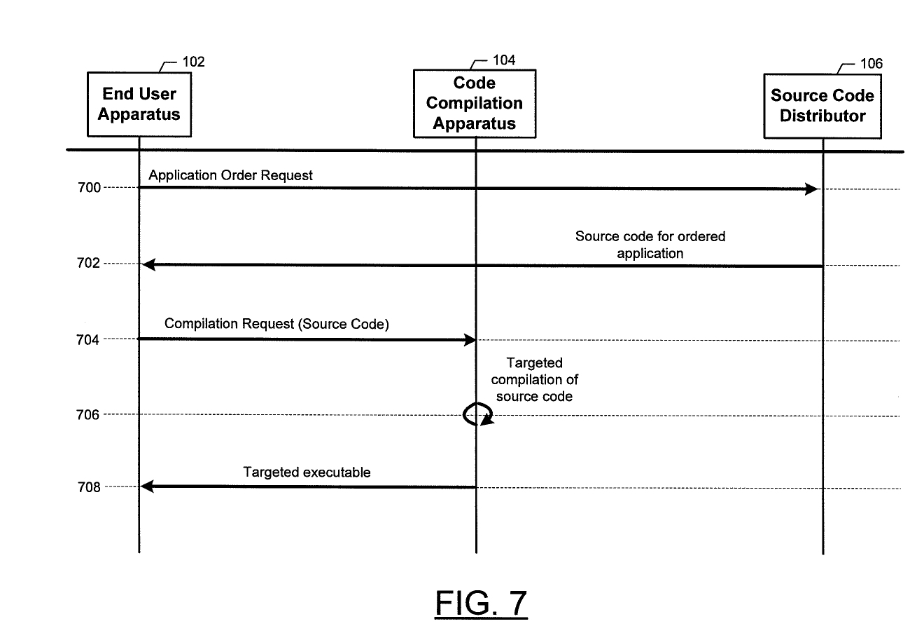

FIG. 7 illustrates a signaling diagram of signals that may be exchanged between entities of the system 100 for facilitating targeted compilation of source code according to another example embodiment of the invention. Operation 700 may comprise the end user apparatus 102 sending an application order request for an application to the source code distributor 106. Operation 702 may comprise the source code distributor 106 sending the source code for the ordered application to the end user apparatus 102. Operation 704 may comprise the end user apparatus 102 sending a compilation request including the source code to the code compilation apparatus 104. Operation 706 may comprise the code compilation apparatus 104 compiling the source code into an executable that is targeted to an intended execution platform of the end user apparatus 102. Operation 708 may comprise the code compilation apparatus 104 sending the targeted executable to the end user apparatus 102. Accordingly, while the user may initiate the targeted compilation by ordering an application, the targeted compilation may be performed without any further user input. Thus, while the user may perform operations in the background on the end user apparatus 102 while targeted compilation is occurring, from the user's perspective, once the targeted executable is delivered to the end user apparatus 102 subsequent to placement of the order, the application may be ready to use. In this regard, the targeted compilation may be transparent to the user.

Some example embodiments further provide for retargeting an application. In this regard, a configuration of an end user apparatus 102, user preferences, and/or the like may change over time. As another example, an unbalanced load profile may affect the execution platform. In this regard, it may be advantageous to have the application retargeted to take advantage of another execution platform (e.g., another processor) on the end user apparatus 102. However, the other execution platform may have a different configuration, instruction set, and/or the like, that requires retargeting of the application. Accordingly, the application circuitry 128 and/or user of the end user apparatus 102 may request that an application be retargeted according to a changed configuration, changed preferences, and/or the like.

If the original source code for an application to be retargeted is not stored at or otherwise available to the end user apparatus 102 (e.g., in embodiments wherein the original targeted compilation was performed in accordance with the signaling diagram of FIG. 6), the application circuitry 128 may send a retargeting request to the source code distributor 106. The source code distributor 106 may then send the source code for the application to be retargeted to the code compilation apparatus 104 for targeted compilation. The source code sent to the code compilation apparatus 104 may comprise the same source code version previously compiled for the end user apparatus 102. Alternatively, the source code sent to the code compilation apparatus 104 may comprise an updated version of the source code previously compiled for the end user apparatus 102. The compilation circuitry 138 may compile the source code as previously described, taking into account updated information about the intended execution platform. The compilation circuitry 138 may send the retargeted executable to the end user apparatus 102, which may then execute the new executable.

If the original source code for an application to be retargeted is stored at or otherwise available to the end user apparatus 102 (e.g., in embodiments wherein the original targeted compilation was performed in accordance with the signaling diagram of FIG. 7), the application circuitry 128 may send a retargeting request to the code compilation apparatus 104 along with the source code. The compilation circuitry 138 may compile the source code as previously described, taking into account updated information about the intended execution platform. The compilation circuitry 138 may send the retargeted executable to the end user apparatus 102, which may then execute the new executable.

Targeted compilation in accordance with an example embodiment of the invention may additionally be applied as part of application execution to fulfill just-in-time (JIT) requirements for an application. For example, consider Java applications. Java applications may require a Java environment (e.g., a virtual machine) to be executed. The compilation circuitry 138 may be configured to serve as the interpreter, compiler, and the environment between the source code distributor 106 and end user as well as between source code and executable. In situations wherein the end user apparatus 102 does not have an execution platform that supports Java, the compilation circuitry 138 may be configured to compile the application into an executable native to an execution platform of the end user apparatus 102.

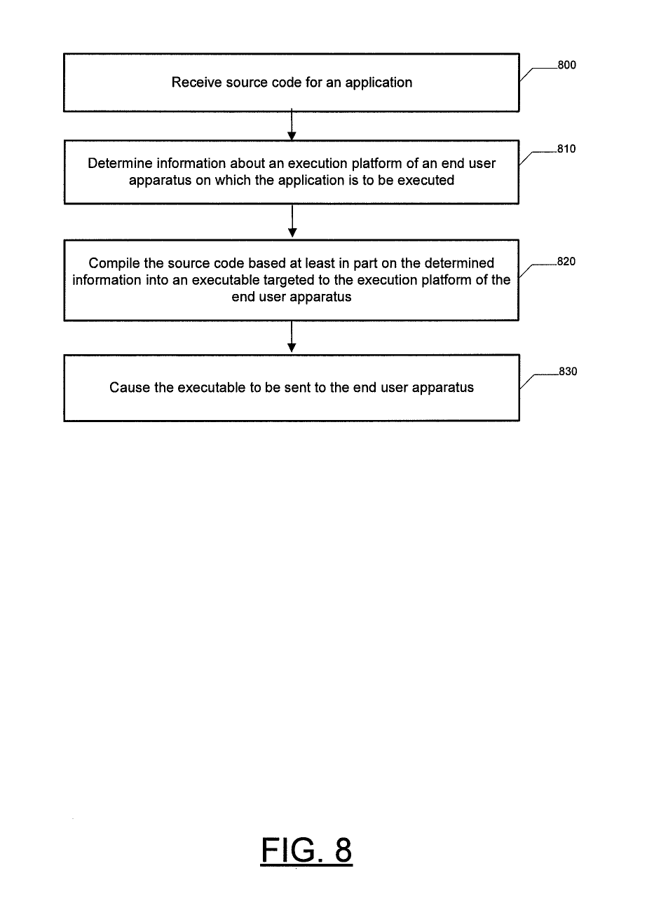

FIG. 8 illustrates a flowchart according to an example method for facilitating targeted compilation of source code according to an example embodiment of the invention. In this regard, FIG. 8 illustrates operations that may, for example, be performed at the code compilation apparatus 104. The operations illustrated in and described with respect to FIG. 8 may, for example, be performed by and/or under control of one or more of the processor 130, memory 132, communication interface 134, user interface 136, or compilation circuitry 138. Operation 800 may comprise receiving source code for an application. Operation 810 may comprise determining information about an execution platform of an end user apparatus on which the application is to be executed. Operation 820 may comprise compiling the source code based at least in part on the determined information into an executable targeted to the execution platform of the end user apparatus. Operation 820 may additionally comprise one or more of performing code assessment on the source code, virus checking the source code, and/or the like prior to or concurrent with compiling the source code. Operation 830 may comprise causing the executable to be sent to the end user apparatus.

FIG. 8 is a flowchart of a system, method, and computer program product according to example embodiments of the invention. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device and executed by a processor in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories (e.g., memory 122 and/or memory 132) on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (e.g., the end user apparatus 102 and/or code compilation apparatus 104) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (e.g., the processor 120 and/or processor 130) may provide all or a portion of the elements. In another embodiment, all or a portion of the elements may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention provide several advantages to application developers, application distributors, computing devices, and computing device users. Example embodiments of the invention provide targeted, on-demand compilation of source code. In this regard, example embodiments provide on-the-fly compilation of source code for a requesting end-user that is targeted to an end-user's apparatus. Accordingly, application developers and distributors may develop a single application source code that may be targeted on demand for a variety of execution platforms without knowledge of the execution platform(s) on which the application will ultimately be implemented. Example embodiments further provide for targeted compilation of source code without imposing any requirement on end user apparatuses to compile the source code. In this regard, example embodiments implement targeted compilation as a network service that may compile source code prior to delivery to an end user apparatus and/or at the request of an end user apparatus. Accordingly, end user apparatuses are not burdened by the processing requirements of compilation. Further, end users are not burdened with compiling the source code and thus are not required to possess the technical knowledge of how to compile source code such that the compiled executable is compatible with their computing devices. Accordingly, both users and developers may benefit from example embodiments of the invention. In this regard, the targeted compilation may be automated and transparent to the end user while saving the developer the trouble of having to develop and maintain several targeted versions of software.

Example embodiments additionally provide for subsequent recompilation (e.g., retargeting) of source code for an end user apparatus for which the source code has been previously compiled (e.g., targeted). Accordingly, applications may be retargeted to account for changes in hardware and/or software configurations of an execution platform. Further, embodiments provide for retargeting to accommodate changed user preferences and/or runtime load balancing. Additionally, example embodiments provide for retargeting in instances where an end user apparatus comprises a plurality of processors having different instruction sets such that source code may be retargeted to facilitate execution on a different execution platform of a computing device.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
receiving source code for an application;
determining information about an execution platform of an end user apparatus on which the application will be executed;
compiling the source code, by compiling circuitry, based at least in part on the determined information into an executable targeted to the execution platform of the end user apparatus; and
causing the executable to be sent to the end user apparatus.

2. The method of claim 1, wherein receiving source code comprises receiving source code sent by a source code distributor in response to a request by the end user apparatus or an end user of the end user apparatus.

3. The method of claim 1, wherein receiving source code comprises receiving source code sent by the end user apparatus, the end user apparatus having previously received the source code from a source code distributor.

4. The method of claim 1, wherein receiving source code comprises receiving source code in response to a request for a retargeted executable to replace a previously compiled executable targeted to the execution platform.

5. The method of claim 1, wherein the source code comprises source code developed independent of knowledge of the execution platform of the end user apparatus.

6. The method of claim 1, wherein the determined information comprises information about one or more of a hardware configuration of the execution platform, an operating system implemented on the execution platform, one or more applications implemented on the execution platform, runtime platform load profiling for the execution platform, resource usage statistics for the execution platform, a type of the end user apparatus, a runtime library implemented on the execution platform, a capability of a user interface of the end user apparatus, a preference of an end user of the end user apparatus, information obtained from a network operator, or information obtained from a service provider.

7. The method of claim 1, further comprising determining identification information identifying the end user apparatus, and wherein determining information about the execution platform of the end user apparatus comprises using the determined identification information to obtain information about the execution platform.

8. The method of claim 7, wherein the identification information comprises one or more of a serial number of the end user apparatus, a phone number of the end user apparatus, an international mobile equipment identity of the end user apparatus, or a username of an end user of the end user apparatus.

9. An apparatus comprising at least one processor and at least one memory storing computer program code, wherein the at least one memory and stored computer program code are configured, with the at least one processor, to cause the apparatus to at least:
receive source code for an application;
determine information about an execution platform of an end user apparatus on which the application will be executed;
compile the source code based at least in part on the determined information into an executable targeted to the execution platform of the end user apparatus; and
cause the executable to be sent to the end user apparatus.

10. The apparatus of claim 9, wherein the at least one memory and stored computer program code are configured, with the at least one processor, to cause the apparatus to receive source code by receiving source code sent by a source code distributor in response to a request by the end user apparatus or an end user of the end user apparatus.

11. The apparatus of claim 9, wherein the at least one memory and stored computer program code are configured, with the at least one processor, to cause the apparatus to receive source code by receiving source code sent by the end user apparatus, the end user apparatus having previously received the source code from a source code distributor.

12. The apparatus of claim 9, wherein the at least one memory and stored computer program code are configured, with the at least one processor, to receive source code by receiving source code in response to a request for a retargeted executable to replace a previously compiled executable targeted to the execution platform.

13. The apparatus of claim 9, wherein the determined information comprises information about one or more of a hardware configuration of the execution platform, an operating system implemented on the execution platform, one or more applications implemented on the execution platform, runtime platform load profiling for the execution platform, resource usage statistics for the execution platform, a type of the end user apparatus, a runtime library implemented on the execution platform, a capability of a user interface of the end user apparatus, a preference of an end user of the end user apparatus, information obtained from a network operator, or information obtained from a service provider.

14. The apparatus of claim 9, wherein the at least one memory and stored computer program code are configured, with the at least one processor, to further cause the apparatus to:
determine identification information identifying the end user apparatus; and
wherein the at least one memory and stored computer program code are configured, with the at least one processor, to cause the apparatus to determine information about the execution platform of the end user apparatus by using the determined identification information to obtain information about the execution platform.

15. The apparatus of claim 14, wherein the identification information comprises one or more of a serial number of the end user apparatus, a phone number of the end user apparatus, an international mobile equipment identity of the end user apparatus, or a username of an end user of the end user apparatus.

16. A computer program product comprising at least one computer-readable storage medium having computer-readable program instructions stored therein, the computer-readable program instructions comprising:
program instructions configured to receive source code for an application;
program instructions configured to determine information about an execution platform of an end user apparatus on which the application will be executed;
program instructions configured to compile the source code based at least in part on the determined information into an executable targeted to the execution platform of the end user apparatus; and
program instructions configured to cause the executable to be sent to the end user apparatus.

17. The computer program product of claim 16, wherein the program instructions configured to receive source code comprise program instructions configured to receive source code sent by a source code distributor in response to a request by the end user apparatus or an end user of the end user apparatus.

18. The computer program product of claim 16, wherein the program instructions configured to receive source code comprise program instructions configured to receive source code sent by the end user apparatus, the end user apparatus having previously received the source code from a source code distributor.

19. The computer program product of claim 16, wherein the program instructions configured to receive source code comprise program instructions configured to receive source code in response to a request for a retargeted executable to replace a previously compiled executable targeted to the execution platform.

20. The computer program product of claim 16, wherein the determined information comprises information about one or more of a hardware configuration of the execution platform, an operating system implemented on the execution platform, one or more applications implemented on the execution platform, runtime platform load profiling for the execution platform, resource usage statistics for the execution platform, a type of the end user apparatus, a runtime library implemented on the execution platform, a capability of a user interface of the end user apparatus, a preference of an end user of the end user apparatus, information obtained from a network operator, or information obtained from a service provider.
